(19) United States
(12) Patent Application Publication
(10) Pub. No.: US 2018/0175629 A1
(43) Pub. Date: Jun. 21, 2018

(54) Mobile Disaster Survival System

(71) Applicant: Andreea Cornelia Andrei, Albuquerque, NM (US)

(72) Inventor: Andreea Cornelia Andrei, Albuquerque, NM (US)

(21) Appl. No.: 15/383,944

(22) Filed: Dec. 19, 2016

(51) Int. Cl. H02J 5/00; B60P 3/00; B62D 63/08

(52) U.S. Cl. CPC H02J 5/00; B62D 63/08; B60P 3/00

(57) ABSTRACT

The present invention is a complete mobile disaster survival system which provides a standalone survival package containing three or more electrical power sources, food and water for four people for five days, a potable water purification and storage means, a means for food storage and preparation, an emergency broadcast radio set, and immediately accessible survival tools, as well as first aid and other equipment. Energy storage devices and sensitive electronic equipment are protected by hydrogen vent fans and Faraday cages. The small footprint allows the system to be pre-located at individual homes or businesses, or rapidly deployed from distribution centers by either manpower, automobile, en masse by semitrailer, or by an airdrop system. The unique advantage of the present invention is the combination of all aspects of emergency survival needs in a compact transportable system.

### FIELD OF THE INVENTION

This invention relates generally a mobile disaster survival system. More particularly, the present invention provides a standalone survival package with water, food, survival gear and tools, and three or more electric power sources that can be pre-located or rapidly deployed by either manpower, automobile, en masse by semitrailer, or by an airdrop system.

### BACKGROUND OF THE INVENTION

Climate change has recently been blamed for many of the large and varied calamities around the world: hurricanes, tornados, earthquakes, tsunamis, and severe floods. Whatever the cause, the United States has not escaped these natural or man-made disasters. Examples include the near total Northeast blackout of 2003, the massive flooding by Katrina in 2005, the devastation of Ike in September of 2008 and more recently, the historic June 2016 floods in Houston, and the August 2016 Louisiana flooding that devastated Baton Rouge.

The one constant during all disasters is the need for electrical power immediately after an event. These calamities create road blockages wherein some regions can go for days without a restoration of power. Basing emergency electrical power only upon a depletable energy source or upon only one source of renewable energy is not the optimum decision. What is needed, then, is an easily deployable, portable, multiple source electrical energy platform with means for both collection, generation, storage and ease of use of energy.

Disaster supplies also include water, food, cooking materials, first aid equipment, and survival tools. Disaster supplies are delivered by a multitude of means, such as autos, trucks, boats, semitrailers and dropped by parachute from an airplane in an airdrop delivery. Transport and distribution of adequate supplies is always problematic during and immediately after an event. Delivery of potable water poses particular difficulties since water delivered in large containers is heavy and typically cannot be hand carried out by soldiers or relief workers. Therefore, individual and community preparedness is key to survival.

There is thus a need for an improved standalone mobile disaster survival system with water, food, and other survival supplies, as well as multiple electric power sources that are not reliant solely on fossil fuel. The present invention provides such a standalone survival package that meets this need and can be pre-located or easily relocated as rapidly as possible as survival requirements evolve. Due to the compact design and small footprint, the invention can be securely stored in garages, the exterior of homes, businesses or distribution centers, all without the typical storage battery loss of 1.5% energy content per month. Sensitive electronics are protected from electrical storm effects by Faraday Cages. The system may be rapidly deployed by either manpower, automobile, en masse by semitrailer, or by an airdrop system.

### PRIOR ART

The present invention relates to an all-in-one disaster survival system which includes three electric power sources, water storage and purification, food storage and preparation means, First Aid means, and other emergency tools and survival equipment. These components and capabilities are included in a single weatherproof container with Faraday Cage electronics protection, mounted on a mobility platform that is transportable to any location, including remote locations, by a truck or other transportation vehicle that travels by land, water, or air.

A comprehensive literature and patent search uncovered literally thousands of patents and devices related to one or a combination of several aspects of the present invention. Methods and devices for providing remote power or using hybrid, renewable energy sources are known. There are also many products available with various types of emergency items, such as food, water, first aid kits and other survival equipment.

By way of example, the company EmergencyKits (‘www.emergencykits.com) provides an array of emergency kits, sometimes called disaster kits or survival kits, with food or specialty supplies for residences, offices, automobiles, schools and others, including Community Emergency Response Teams (CERT), and First Responders. Kits are special ordered by category, comprehensiveness and number of personnel. Similarly, SurvivorBox™ (′www.survivorbox.org) is a nonprofit aggregator and distributor of disaster relief supplies. SurvivorBox™ partners with other non-governmental organizations (NGOs) in meeting their requests for specific items needed by their onsite personnel.

U.S. Pat. No. 8,365,907 to Mooney et al. describes a survival package providing fire making materials and water. The survival package is usable in an airdrop package or as a standalone. U.S. Pat. No. 9,102,350 to Bengtzen describes a multi-function suitcase-sized transportable storage container for emergency or other supplies. U.S. Pat. No. 9,457,902 to Potter et al. describes a cost-effective pack for emergency supplies adapted to be distributed from an aircraft in the event of a natural, military, political, or other disaster.

U.S. Pat. No. 7,631,371 to Dollar is a watertight survival kit that includes food and water in a dual-use container with a packet containing a chemical toilet composition. U.S. Pat. No. 5,353,206 to Fejes comprises an in-ground pyramidal storage container for various components for emergency use relative to natural disasters. U.S. Pat. No. 9,286,440 to Carter et al. is a self-contained emergency situation assistance system, with audio and/or visual or video instructions on use of the medical supplies contained in the kit.

There are many commercial units available with solar panels and other electricity generating equipment on mobile platforms ranging from automobile trailers to transportainers. The company Sun Seeker Mobile Trailer (‘www.solartrailercom; ‘www.mobilesolarpowercom) offers a trailer mounted solar array with sun tracking, batteries, inverter, backup generator, and extra compartments that can be customized for unique uses. U.S. Pat. No. 3,411,050 to Middleton discusses solar cells made of thin film cadmium sulfide which are used in flexible solar arrays wound onto a mandrel for ease of transportation. CT Solar (‘www.ctsolarcom) markets such flexible/foldable disaster/hurricane solar power systems with storage case, battery, folding panels, and mounts. SolaRover Inc (‘solarovercom) markets large flatbed trailers with deployable solar cell arrays supplemented with wind powered or propane powered generators and battery support based on U.S. Pat. Appl. 20150090315 by Spisak.

U.S. Pat. No. 5,725,062 to Froneck describes a solar power design where the solar panel is mounted on the top of a vehicle. U.S. Pat. No. 9,046,281 to Curran describes a wheeled support frame and solar panel deployment system with batteries. U.S. Pat. No. 9,324,893 to Kats et al., U.S. Pat. No. 5,969,501 to Glidden et al., U.S. Pat. No. 8,492,645 to Strahm, and U.S. Pat. No. 8,716,889 to Vaidyanathan all discuss folded solar arrays mounted on various mobility platforms.

U.S. Pat. No. 9,184,628 to Carpoff, U.S. Pat. No. 7,795,837 to Haun et al., U.S. Pat. No. 8,921,685 to Razin et al., U.S. Pat. No. 9,428,100 to Sharpley et al., and U.S. Pat. No. 4,452,234 to Withjack discuss various towable solar power systems including a trailer, one or more batteries, a battery management system, an inverter and a power outlet. U.S. Pat. No. 5,379,596 to Grayson shows a device-specific folding solar collector array that is used to power a portable refrigerator or heated storage chest.

There are many hybrid energy systems available comprised of solar panels, batteries, generators, wind turbines, and other electricity generating equipment on mobile platforms. U.S. Pat. No. 7,821,147 to Du Bois discloses a portable, tow-able, buoyant hybrid energy production platform using wind, water, and solar power, as well as a backup generator. U.S. Pat. No. 7,469,541 to Melton et al., U.S. Pat. No. 8,299,645 to Murchow et al., U.S. Pat. No. 8,299,645 to Bullivant et al., U.S. Pat. No. 8,879,242 to Prax et al., U.S. Pat. No. 7,105,940 to Weesner et al., and U.S. Pat. No. 9,441,612 to Haar, all disclose various hybrid power systems comprising a solar energy system, batteries, a back-up generator, and in some cases a wind energy system. The components are disposed on platforms that are portable and transportable to remote locations by multiple means.

U.S. Pat. No. 6,559,552 to Ha utilizes four sources of energy: rain, wind, wave, and solar. U.S. Pat. No. 6,100,600 to Pflanz discloses an energy platform that uses hydroelectric power, wind power, and solar radiation. U.S. Pat. No. 6,172,429 Russell discloses a stationary solar, wind, and water energy platform. U.S. Pat. No. 4,206,608 to Bell discloses a system using solar, wind, and wave energy. Portability is not disclosed.

While the prior art discloses many individual aspects of the current invention, no all-in-one survival system was found which includes three electric power sources, water storage and purification, food storage and preparation means, First Aid supplies, and survival gear and tools all in a single container mounted on a weatherproof mobility platform with Faraday Cage electronics protection. The prior art thus does not address the need to provide a combination of the above mentioned capabilities, nor the capability to be either pre-located or rapidly delivered to remote sites as needed.

### SUMMARY OF THE INVENTION

The primary object of the present invention is to provide for a complete standalone mobile disaster survival system. The system comprises a compact mobile storage container and mobility platform having a small footprint that allows the system to be stored in many different locations where it can be quickly and easily accessed or deployed in the event of a disaster. The unique advantage of the present invention is the combination of all aspects of disaster survival needs in a compact transportable system.

In a preferred embodiment, a weatherproof container includes three or more electrical power sources, food and water for four people for five days, a means for food storage and preparation, a potable water purification means, emergency broadcast radio set, and immediately accessible survival tools, as well as first aid and other equipment. Energy storage devices and sensitive electronic equipment are protected by hydrogen vent fans and Faraday cages.

The container is attached to a mobility platform, which is easily transportable by manpower or by virtually any mechanical means, and may also be delivered en masse on semitrailers or from disaster relief aircraft. The convenience provided by this system is another key advantage of the invention.

These and other objects, advantages and novel features, and further scope of applicability, of the present invention will become apparent to those skilled in the art upon examination of the following descriptions of embodiments of the invention, with reference to the accompanying detailed drawings, as well as the appended claims.

### BRIEF DESCRIPTION OF THE DRAWINGS

The accompanying drawings, which are incorporated in and form part of the specification, illustrate various elements and principles of operation of the present invention, including a preferred embodiment of the invention, and, together with the detailed description, serve to explain the principles of the invention.

FIG. 1 presents an isometric view of a preferred embodiment of the container mounted on a non-highway version of the mobility platform.

FIG. 2 presents an isometric view of a preferred embodiment of the container mounted on a commercial auto trailer version of the mobility platform.

FIG. 3 presents an isometric view of a preferred embodiment of the container illustrating the access ports.

FIG. 4 presents a fore-to-aft centerline section side view illustrating the specific compartments of a preferred embodiment of the container.

FIGS. 5A, 5B, and 5C present three options for the renewable energy collection system photovoltaic panels.

FIG. 6 presents an isometric view illustrating one version of deployed rigid and foldable solar panels comprising part of the renewable energy collection system.

FIG. 7 presents an isometric view illustrating one version of deployed rigid and flexible/rollable solar panels comprising part of the renewable energy collection system.

FIG. 8 presents a schematic illustrating some components of the energy storage system.

FIG. 9 presents a schematic illustrating the components of the hydrocarbon fueled energy generation system.

FIG. 10 presents a schematic illustrating the components of the potable water generation and storage system.

FIG. 11 presents a schematic illustrating the components of the food storage and preparation system.

FIG. 12 presents a schematic illustrating the components of the survival gear and tools system.

FIG. 13 presents the electrical wiring diagram schematic for the electronic control system connecting the renewable energy collection system, the energy generation system, and the energy storage system.

FIG. 14 presents an exploded schematic illustrating how the components and systems of a preferred embodiment of the present invention are assembled.

FIG. 15 presents a cutaway top view of an enlarged version of a preferred embodiment of the container.

FIG. 16 presents a schematic illustrating one version of a deployable wind-turbine component of the renewable energy collection system.

### DETAILED DESCRIPTION OF PREFERRED EMBODIMENTS

The present invention will now be described more fully hereinafter with reference to the accompanying drawings, wherein like numbers refer to like elements throughout. Individual components of preferred embodiments as well as descriptions of the integrated system are presented.

A first preferred embodiment of the mobile disaster survival system consists of a weather-proof container with specialized compartments that is attached to a highway transportable mobility platform designed to be transported by virtually any mechanical means. A second preferred embodiment consists of the container attached to a mobility platform variant which is not highway transportable but is easily moveable by a single person in the manner of a shopping cart.

The various specialized compartments in the container include three or more electrical power sources comprised of a renewable energy collection system, a conventional hydrocarbon fueled energy generation system, and an energy storage system. In addition, the container includes a potable water generation and storage system, a food storage and preparation system with supplies for four people for five days, a means for both cooking and serving food, and an immediately accessible survival gear and tools system including such items as a first aid kit, flashlights, rain gear, thermal blankets, hand tools, and an emergency broadcast radio receiver,

The electrical power sources in a preferred embodiment can have a plurality of solar panels and associated charge controllers mounted in or on the container. The container includes a hydrocarbon fueled electric generator, a plurality of rechargeable batteries, a battery management system, an inverter and power outlets, and a unique wiring and control system for coordinated operations and component status monitoring.

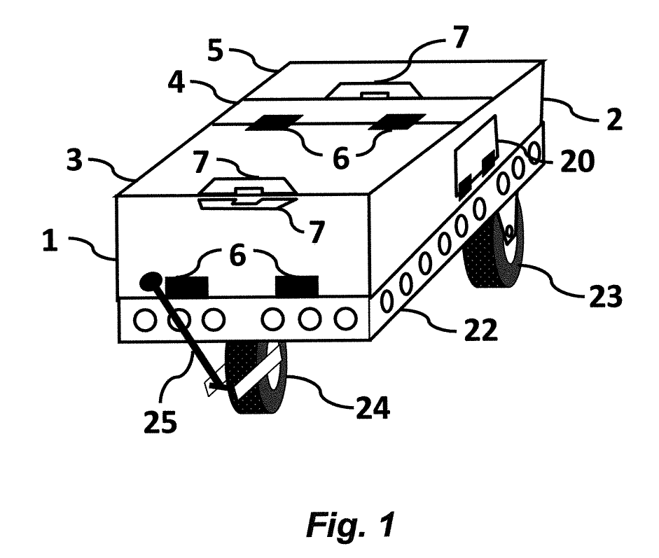

FIG. 1 presents an isometric view of a container as attached to a non-highway version of the mobility platform. The container may be removably attached to the mobility platform by various mechanical means, or permanently attached by bolts and construction adhesive. The container consists of a front ramp 1, longitudinal sides 2, fixed top front panel 3, top center access door 4, top rear fixed panel 5, side door 20 for accessing electronics, hinges 6, and opening handle 7. The front ramp 1 is designed to provide access to the energy generation system compartment and also to serve as a platform for open air operation of the hydrocarbon-fueled generator. The top center access door 4 is designed to provide access to both the energy storage system and the survival gear and tools system storage compartments. FIG. 1 also illustrates the general structure of the mobility platform, which is designed to be moved by hand in the manner of a grocery cart, including the mobility system lightweight frame 22, two rear fixed caster wheels 23, a front swivel caster wheel 24, and a towing handle 25.

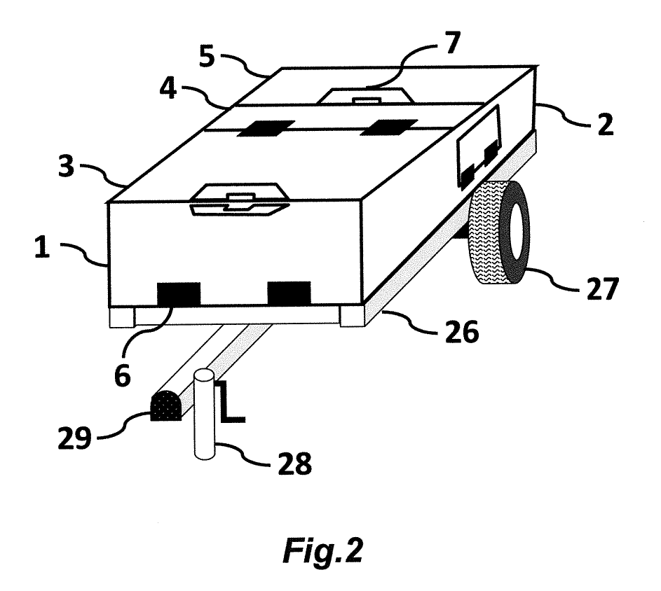

FIG. 2 presents an isometric view of a container as attached to a commercial trailer thus forming a highway transportable version of the mobility platform. The container may be removably attached to the mobility platform by various mechanical means, or permanently attached by bolts and construction adhesive. The container consists of a front ramp 1, longitudinal sides 2, fixed top front panel 3, top center access door 4, top rear fixed panel 5, side door 20 for accessing electronics, hinges 6, and opening handle 7. The front ramp 1 is designed to provide access to the energy generation system compartment and also to serve as a platform for open air operation of the hydrocarbon-fueled generator. The top center access door 4 is designed to provide access to both the energy storage system and the survival gear and tools system storage compartments. FIG. 2 also illustrates the general structure of the mobility platform, which is designed to be moved by automobile, including the mobility system lightweight frame 26, two rear highway-certified wheels 27, a front towing arm with trailer hitch 29, and an adjustable swivel jack 28.

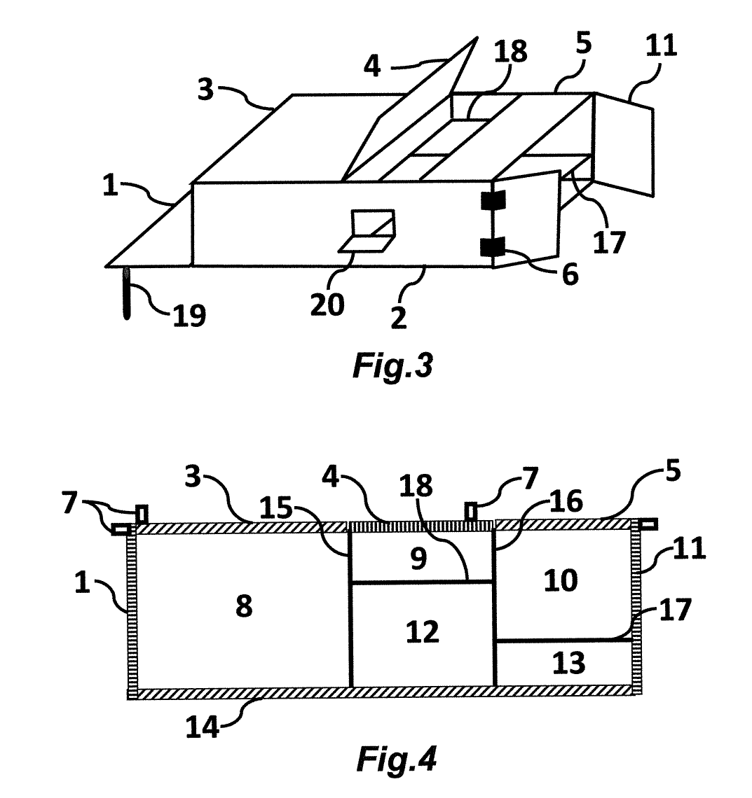

FIG. 3 presents an isometric side view of a preferred embodiment of the container illustrated in FIG. 1. FIG. 3 shows the opened access ports of the container including front ramp 1 with supports 19, rear doors 11, energy storage system and survival gear and tools system top hatch 4, and side electronics access door 20.

FIG. 4 presents a centerline-sectioned side view of the interior of the container illustrated in FIG. 1. Additional structural elements of the container shown in FIG. 4 consist of rear doors 11, container bottom 14, energy storage system compartment lateral walls 15 and 16, survival gear and tools system storage shelves 18, and a storage shelf 17 for food preparation elements. The specially designed compartments of the container, which are sized to efficiently contain certain equipment and supplies, are also shown. Volume 8 is the energy generation system compartment; volume 9 is the survival gear and tools system compartment; volume 10 is the food and water storage and food preparation utensils compartment; volume 13 is the food preparation cooking stove and stove fuel storage compartment; and volume 12 is the compartment for the energy storage system and Faraday Cages.

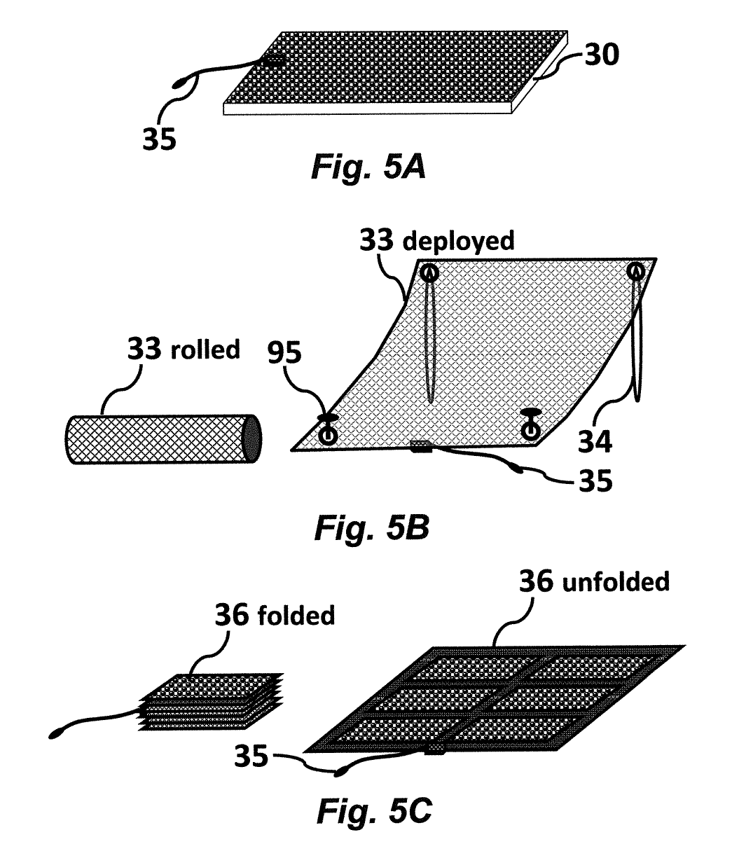

FIGS. 5A, 5B, and 5C present schematics of three renewable energy collection system photovoltaic cell panel options. FIG. 5A presents a rigid photovoltaic panel 30 and the associated electrical connection cable 35. FIG. 5B presents the two forms of a thin film flexible/rollable photovoltaic panel 33 and the associated electrical connection cable 35. The left side of the FIG. 5B shows the panel 33 in a rolled configuration for storage, while the right side of FIG. 5B shows the deployed panel 33. FIG. 5C presents the two forms of a lightweight thin film foldable unit photovoltaic panel 36 and the associated electrical connection cable 35. The left side of the FIG. 5C shows the panel 36 folded for storage, while the right side of FIG. 5C shows the deployed unfolded panel 36. The preferred embodiment for the present invention includes at least one rigid frame photovoltaic panel 30 externally attached to the container, and one or more thin film flexible/rollable panels 33 or foldable photovoltaic panels 36 normally secured inside the container and deployed only as desired.

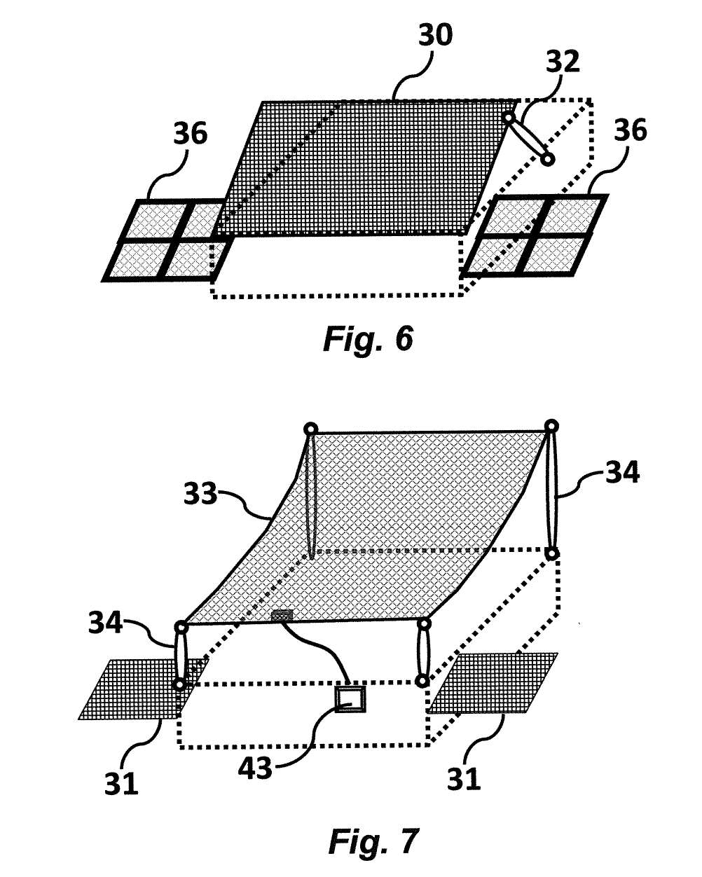

FIG. 6 presents a schematic of one possible configuration of a deployed rigid solar panel 30 and folded solar panels 36 for renewable energy collection. Structural element 32 is used to position the larger panel 30 at a desired tilt angle for optimum solar incidence. The dashed lines represent a container. The preferred embodiment of the present invention includes at a minimum at least one rigid solar panel 30 and either one flexible/rollable solar panel 33 as shown in FIG. 5B or one foldable solar panel 36 as shown in FIG. 5C stored within the container and deployed as needed.

FIG. 7 presents a schematic of another possible configuration of a deployed flexible/rollable solar panel 33 with charge controller 43, and two deployed small rigid solar panels 31 for renewable energy collection. Adjustable structural elements 34 are used to position the large deployed flexible/rollable panel 33 at any desired tilt angle for optimum solar incidence. The dashed lines represent a container. The preferred embodiment of the present invention includes at a minimum at least one rigid solar panel 30 and either one flexible/rollable solar panel 33 as shown in FIG. 5B or one foldable solar panel 36 as shown in FIG. 5C which is stored within the container and deployed as needed.

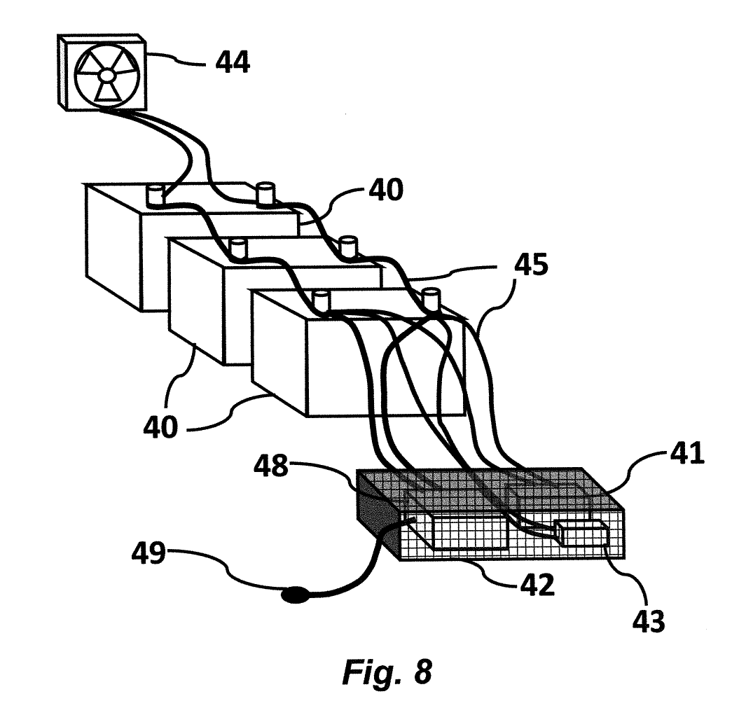

FIG. 8 presents a schematic diagram of the energy storage system. The basic components of the energy storage system include one or more deep-cycle rechargeable batteries 40, a DC to AC inverter 41, a charge controller 43, a battery charger 48, an external charger cable 49, connecting cables 45, and one or more hydrogen ventilation fans 44. The inverter 41, battery charger 48, and charge controller 43 are housed in a Faraday Cage 42 so as to protect the electronics from electromagnetic pulse (EMP) effects, such as may be generated from nearby lightning strikes. Several options are available for deep cycle batteries 40, including sealed lead acid, absorbed glass mat, gel cells, and lithium iron phosphate cells.

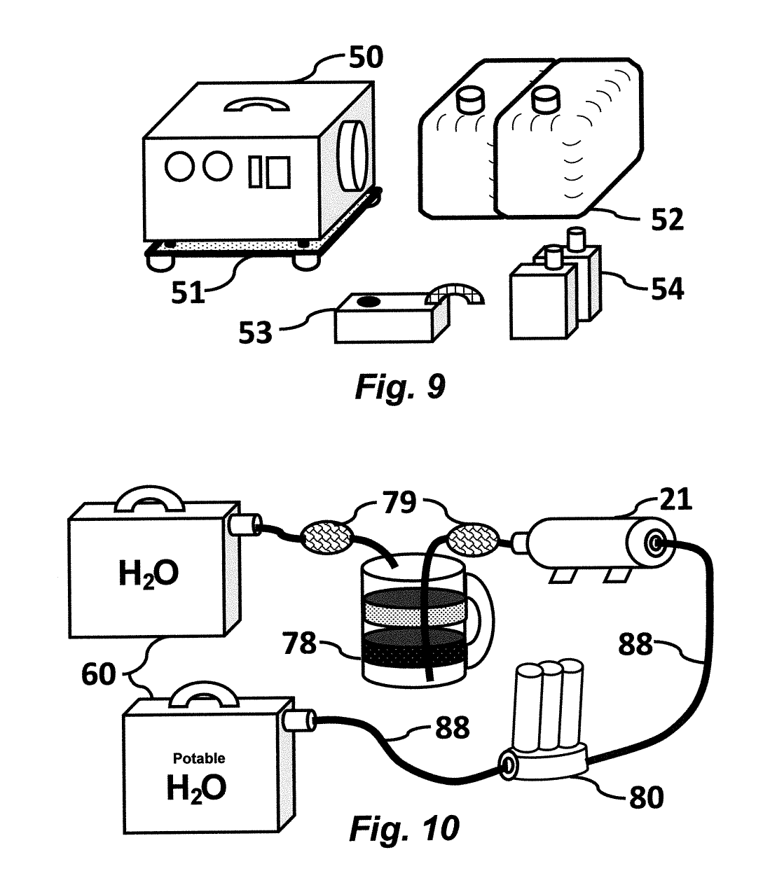

FIG. 9 presents a schematic diagram of the energy generation system. The basic components of the energy generation system include one hydrocarbon-fueled electricity generator 50, one or more hydrocarbon fuel containers 52, bottles 54 containing lubricating oil for the generator, and a small fueling container 53 with flexible spigot. Several options are available for the electricity generator 50, including manual start two-cycle, manual start four-cycle, and electric start four-cycle. The preferred embodiment of the present invention includes an 800 W-1200 W generator 50, two 5-gallon fuel containers 52, one or more oil bottles 54, and a 1-gallon fueling container 53.

FIG. 10 presents the components of the potable water generation and storage system components comprising at least two 6-gallon water containers 60, one or more manual siphon hoses 79, a passive multi-layer water filter 78, an electrically powered Ultra-Violet light bacterial sterilizer 21, water transfer tubes 88, and an electrically powered reverse-osmosis water purifier 80. The components are assembled and used in series as shown in FIG. 10 to produce potable water. A preferred embodiment of the present invention includes at a minimum all of the items shown in FIG. 10.

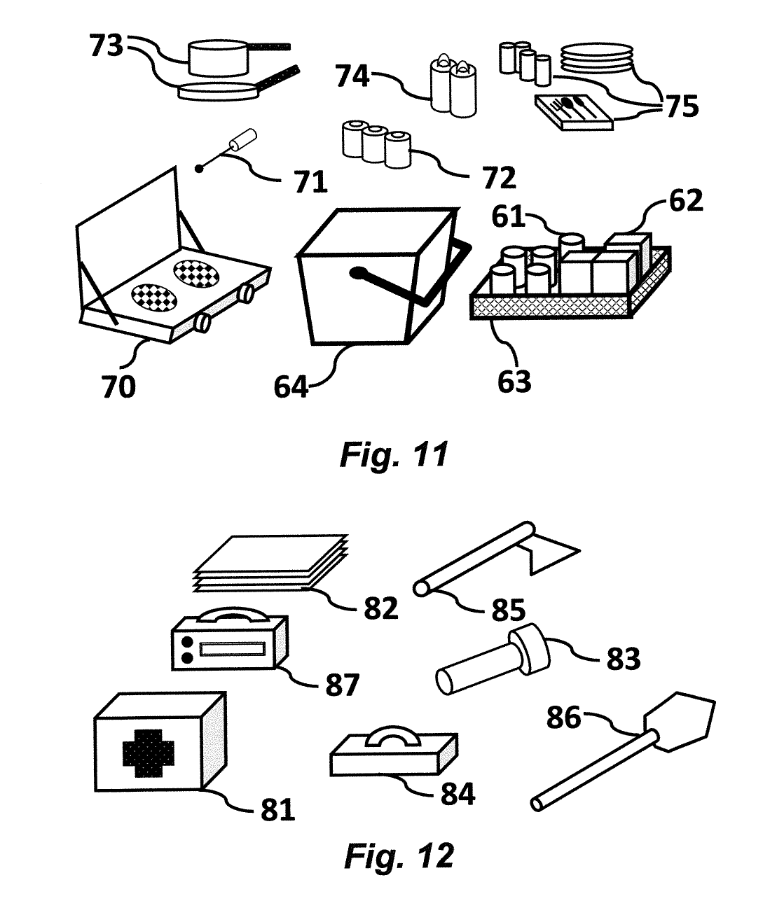

FIG. 11 presents a schematic of the basic components of the non-perishable rations and food preparation system, such as a freeze-dried food pail 64, a storage rack 63 with canned foods 61 and dried packaged foods 62, one 2-burner camp stove 70, one or more fuel containers 72 for the stove, cooking utensils 73, food serving utensils 75, and utensil cleaning and disinfecting wipes 74. Several options are available for the stove 70 and required fuel containers 72, such as propane, butane and Sterno. A preferred embodiment of the present invention includes at a minimum all of the items shown in FIG. 11.

FIG. 12 presents a schematic of some of the recommended basic components of the survival gear and tools system, such as one reverse-osmosis water purification unit 80, one extensive first aid kit 81, four thermal blankets 82, one or more rechargeable battery-powered hand-portable light sources 83, a mechanical tool kit 84, a small axe or hatchet 85, a small military-style collapsible shovel 86, and an emergency broadcast radio receiver 87. A preferred embodiment of the present invention includes at a minimum all of the items shown in FIG. 12.

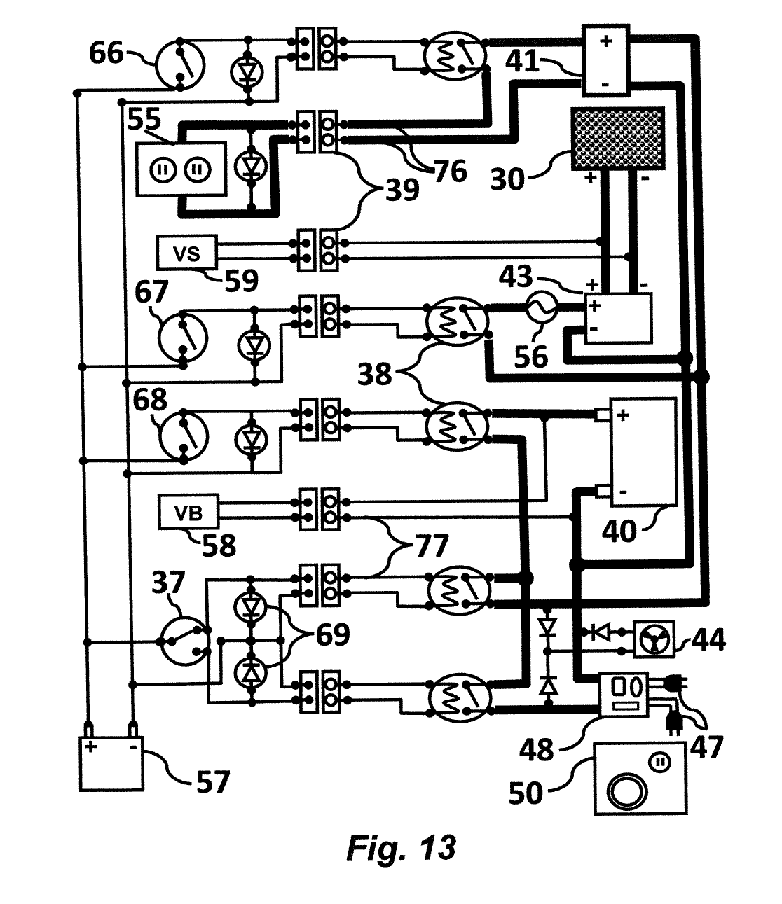

FIG. 13 presents a schematic illustrating the electronic control system wiring diagram of the general electrical connections for system control and component status in a preferred embodiment. While only a single battery 40 and a single solar panel 30 are shown, it is to be understood that these represent a multiplicity of batteries and solar panels.

Referring to FIG. 13, the DC inputs for inverter 41 include both charge controller 43 and battery 40. AC output of inverter 41 is controlled by switch 66 operating a relay of type 38 which connects the output of the inverter to AC power outlets 55. The switch 66 is provided for remote external disconnect of the inverter in the case of inverter overload or insufficient current input for inverter output demand. Solar panel 30 electrical output is connected to the input of charge controller 43 through high current cables, with an attached digital voltage meter 59 for monitoring solar panel output voltage.

Further referring to FIG. 13, the output of charge controller 43 is connected through fuse 56 and a disconnect relay of type 38 controlled by switch 67 through high current cables to both inverter 41, storage battery 40, hydrogen vent fan 44 and external power battery charger 48. Switch 67 is used to disconnect the charge controller 43 from the system at night or during other conditions during which the solar panel 30 isolation is desired.

Further referring to FIG. 13, the storage battery 40 circuit includes a battery output disconnect relay of type 38 controlled by switch 68 and an attached digital voltmeter 58 for monitoring battery voltage. The switch 68 is used to disconnect the battery for either maintenance or other conditions wherein battery isolation is desired.

Further referring to FIG. 13, hydrogen ventilation fan 44 is configured to automatically operate when battery 40 is either charging or discharging. The fan is electrically isolated by three diodes to prevent electricity backflow. A thermal sensor, not shown, is also used in parallel to operate the fan when the battery compartment temperature exceeds a desired limit.

Further referring to FIG. 13, double pole single throw switch 37 is used to direct current from either battery 40 to inverter 41, or from battery charger 48 to battery 40. Status diodes 69 indicate the selected current flow configuration. The external power battery charger 48 may be connected via cables and terminals 47 to either an external AC power source for constant float-charging of battery 40, or to the AC output of generator 50 for remote quick-charging of battery 40.

Further referring to FIG. 13, rechargeable NiCad or rechargeable lithium battery 57 is used to power the low-current switches 37, 66, 67 and 68 for operation of the high-current disconnect relays of type 38 for each major component of the electrical system. On/off status diodes of type 60 are located within the circuit of each switch 37, 66, 67, and 68.

Further referring to FIG. 13, multiple redundant versions of this configuration may exist within a single embodiment of the present invention. For example, one rigid solar panel array 30 may charge one set of batteries 40 and power one inverter 41, while a second solar array may be connected to a second set of batteries and a second redundant inverter. Each set of solar arrays and batteries will thus have its own identical independent wiring system.

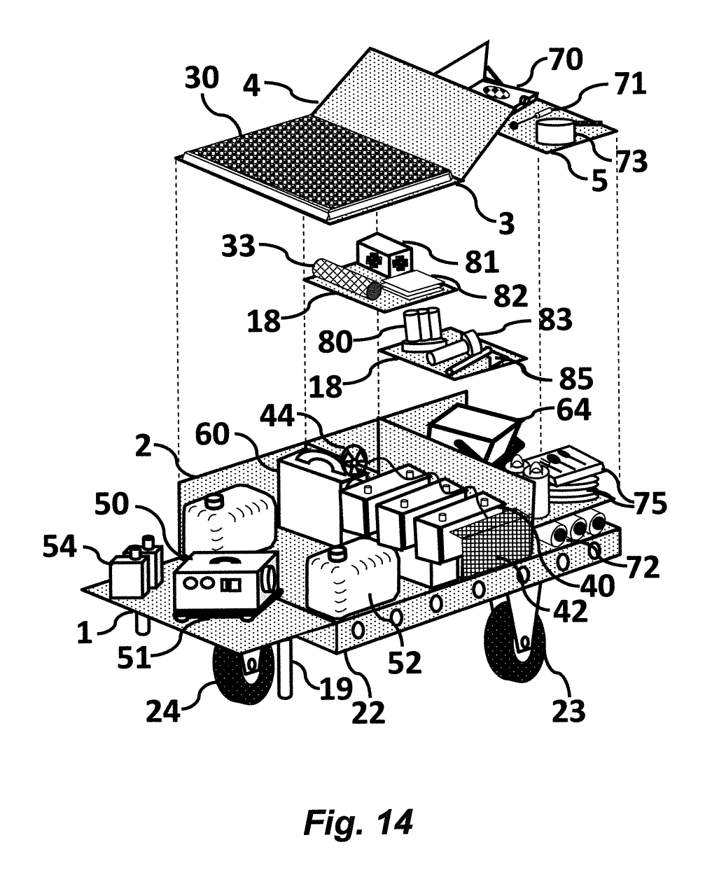

FIG. 14 presents an exploded view schematic of a preferred embodiment of the entire mobile disaster survival system, including a container, a mobility platform, a renewable energy collection system, an energy generation system, an energy storage system, a potable water generation and storage system, a non-perishable rations and food preparation system, and a survival gear and tools system. The numbered items in FIG. 14 have all been described in the previous figures. A preferred embodiment of the present invention includes all of the items shown in FIG. 14, as well as other items described previously for each system.

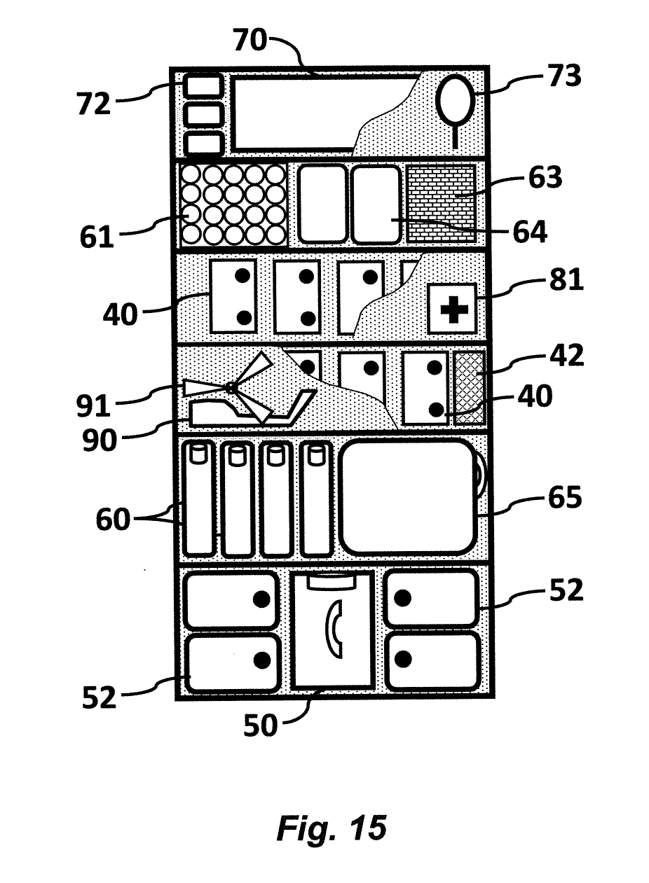

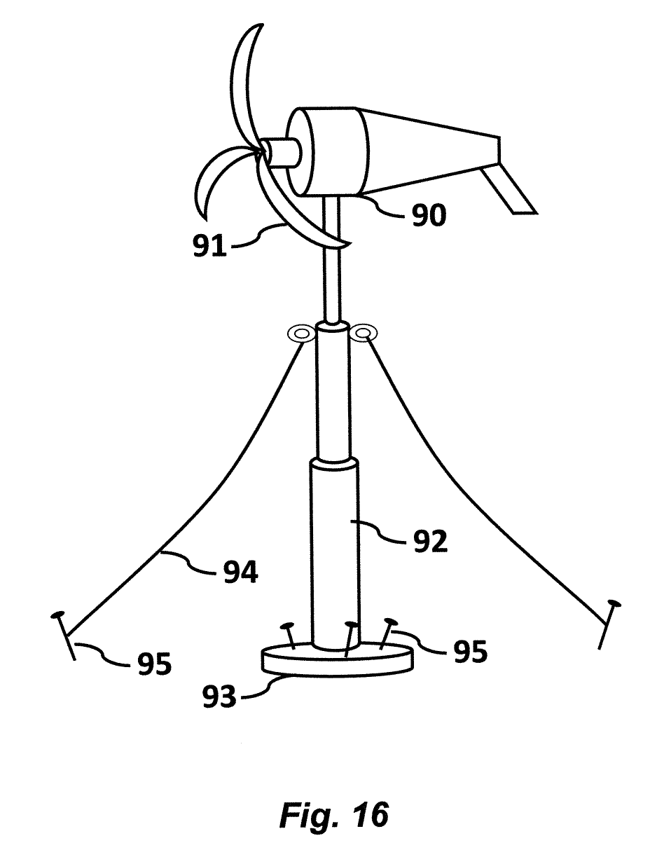

FIG. 15 presents a cutaway top view schematic illustrating components comprising an increased capacity version of the container designed to attach to large commercial mobility platforms. Progressing from the bottom to the top of FIG. 15, the increased capacity container has a first compartment containing a hydrocarbon fueled generator 50 and four fuel storage cans 52. The second compartment contains four 6-gallon water storage containers 60 and a compact refrigerator 65. The third compartment has a lower volume with up to four deep cycle batteries 40 and a Faraday Cage 42 containing electronics for the system. The upper volume of the third compartment contains a deployable wind energy system with turbine 90, blades 91, and other parts as described in subsequent FIG. 16. The fourth compartment has a lower volume with up to four deep cycle batteries 40 and a Faraday Cage (not shown) containing electronics for the system. The upper volume of the fourth compartment contains a first aid kit 81 and other such survival gear and tools as shown in FIG. 12. The fifth compartment contains various food storage elements such as canned goods 61, freeze-dried goods 64 and containers 63 of other dried foods. The sixth and final compartment contains shelves housing the food preparation elements, such as propane canisters 72, propane stove 70 and cooking utensils 73.

FIG. 16 presents a schematic illustrating a deployable wind-energy collection system, which may be included in an increased capacity container such as that illustrated in FIG. 15. The system includes a wind turbine 90, wind vanes 91, a collapsible mounting pole 92, a mounting base plate 93, stabilizing lines 94 and spikes 95 to secure the base plate and stabilizing lines to the ground.

In summary, the primary unique advantage of the present invention is the combination of multiple elements of disaster survival needs in a compact, easily transportable system. These elements include water purification and storage, food storage and preparation means, multiple electrical power sources, and survival gear and tools. These elements are efficiently stored within a container specifically designed for them which is attached to a mobility platform with a small storage footprint. The system thus constitutes an easily accessible, easily transportable, all-purpose survival system that may be relocated by a single person, towed by automobile, or delivered en masse on semitrailers or disaster relief aircraft. The convenience of multiple transport options provided by this system is a major benefit of the invention. Compared to conventional emergency food and water survival packages, or transportable electricity generation systems, the many advantages of the present invention are obvious.

Yet another advantage of the present invention is that it is provides continuous, uninterrupted electricity and other survival supplies to remote sites immediately upon deployment. The system can also be used outside of disaster situations, including for commercial or recreational purposes.

A further unique advantage of the present system is the combination of both rigid and rollable/foldable photovoltaic cells. The rigid panels can remain deployed either tilted or flat even in high winds. The rollable/foldable panels occupy a small footprint during storage and transport, yet provide a large, easily deployed solar energy collective surface without the need for large mechanical array structures as required by many currently available systems.

A further unique advantage of the present invention is the electronic control system for integration and operation of the electrical components. The electronic control system provides for easy-to-use status monitoring, general systems operation, individual component control options, and component disconnects for maintenance. The electronic control system can either be housed in a panel which is hard-mounted to the container, housed in a tethered control box, or configured to be operated by an Infra-Red TV-style remote. Survivability of energy storage devices and sensitive electronic equipment is ensured by hydrogen ventilation and cooling fans and Faraday cages.

It is to be understood that even though numerous characteristics and advantages of the present invention have been set forth in the foregoing description, together with details of the structure and function of the invention, the disclosure is given by way of illustration only. This invention may, however, be embodied in many different forms and should not be construed as limited to the embodiments set forth herein. Changes may be made in detail, especially in matters of shape, size and arrangement of parts within the principles of the invention to the full extent indicated by the broad general meaning of the terms in which the appended claims are expressed. The invention includes all such changes and modifications made within the scope of the present invention without departing from the spirit thereof.

What is claimed is:

1. A mobile disaster survival system comprising:
a weather-proof emergency survival container;
a mobility platform for transporting the container;
a renewable energy collection system;
a conventional electrical energy generation system;
an electrical energy storage system;
a means for charging the energy storage system from the renewable energy collection system;
a means for charging the energy storage system from alternating current electrical sources;
an electronic control system for accessing, operating, monitoring, controlling and maintaining the energy systems;
a means for ventilation and hydrogen exhaust of the energy storage systems;
a means for protection of sensitive electronics against electromagnetic pulse;
a potable water generation and storage system;
a non-perishable rations and food preparation system; and
a specially designed volume for storage of a survival gear and tools system.

2. The system of claim 1 wherein the container may be constructed of various materials or combinations of materials such as wood, fiberglass-coated wood, fiberglass, heavy duty plastics, aluminum sheet, rolled sheet steel, and carbon fiber.

3. The system of claim 1 wherein the container is weatherproofed with special coatings on all exterior surfaces, as well as gaskets, grommets, and watertight seals at all joints, access ports, and access panels.

4. The system of claim 1 wherein the container has various means for being attached to and for being detached from various mobility platforms.

5. The system of claim 1 wherein the container has one or more stabilizing and load bearing supports attached to an access ramp for supporting the energy generation system while the system is deployed outside of the container.

6. The system of claim 1 wherein the mobility platform comprises any commercially available wheeled platform suitable for either manual or vehicle transport of the container.

7. The system of claim 1 wherein the mobility platform comprises a specially designed and manufactured lightweight wheeled platform composed of plywood, fiberglass, carbon composites, and aluminum suitable for vehicle transport of the container.

8. The system of claim 1 wherein the mobility platform comprises a specially designed and manufactured lightweight wheeled platform composed of plywood, fiberglass, carbon composites, and aluminum suitable for garage storage and manual transport of the container.

9. The system of claim 1 wherein the renewable energy collection system comprises one or more rigid photovoltaic solar panels and one or more photovoltaic solar panels which are either foldable, flexible/rollable or a combination thereof.

10. The system of claim 1 wherein the renewable energy collection system may further comprise an erectable wind energy device.

11. The system of claim 1 wherein the conventional energy generation system comprises a hydrocarbon-fueled internal combustion generator and hydrocarbon fuel storage containers.

12. The system of claim 1 wherein the energy storage system comprises one or more rechargeable deep-cycle storage batteries.

13. The system of claim 1 wherein the means for charging the energy storage system from the renewable energy system comprises one or more direct-current electronic charge controllers.

14. The system of claim 1 wherein the means for charging the energy storage system from alternating current sources comprises an alternating-current-to-direct-current voltage and current regulating battery charger.

15. The system of claim 1 wherein the energy control system for accessing and operating the various energy systems comprises an inverter to convert energy from direct-current to alternating-current, electrical relays, extension cords, and electrical outlets.

16. The system of claim 1 wherein the energy control system for monitoring, controlling, and maintaining the various energy systems comprises voltage gauges, current gauges, current routing switches, fuses, connecting wiring, and electrical rapid disconnects for each individual energy system.

17. The system of claim 1 wherein one or more hydrogen ventilation and cooling fans are provided for the energy storage system compartment.

18. The system of claim 1 wherein the means for protecting sensitive electronic equipment from electromagnetic pulse (EMP) effects comprises one or more Faraday Cage which fully encloses sensitive electronics volumes in the container.

19. The system of claim 1 wherein the potable water generation and storage system comprises a multiplicity of water storage containers, passive filters, siphon hoses, an Ultra-Violet light bacterial filter, and an electric reverse-osmosis water purification unit.

20. The system of claim 1 wherein the survival gear and tools comprise First Aid kits, rechargeable battery-powered handheld lights, rain gear, thermal blankets, hand tools, and an emergency broadcast radio receiver.

21. The system of claim 1 wherein the non-perishable rations and food preparation means comprise canned, dry-packaged and freeze-dried rations, a two burner stove, a lighter, stove fuel containers, and cooking and eating utensils.
